(19) United States
(12) Patent Application Publication
(10) Pub. No.: US 2010/0028825 A1
(43) Pub. Date: Feb. 4, 2010

(54) Method and System of Determining and Applying Orthodontic Forces Dependent on Bone Density Measurements

(76) Inventor: Marc Lemchen, New York, NY (US)

Correspondence Address: Law Offices of Daniel L. Dawes;Dawes Patent Law Group, 5200 Warner Blvd, Ste. 106, Huntington Beach, CA, 92649, US

(21) Appl. No.: 12/516,339

(22) PCT Filed: Dec. 27, 2007
(86) PCT No.: PCT/US07/88977

§ 371 Date: May 26, 2009

Related U.S. Application Data
(60) Provisional application No. 60/877,292, filed on Dec. 27, 2006.

(51) Int. Cl. A61C 7/00

(52) U.S. Cl. 433/24; 433/2

(57) ABSTRACT

Orthodontic forces dependent on bone density measurements are determined by measuring bone density data in a scan of at least a portion of the teeth and jaw to produce a visual map of bone density is a selected area of the jaw. A two or three dimensional image of at least a portion of the jaw and teeth in the selected area of the jaw is generated. The bone density image is mapped into the two or three dimensional image. The attachment points on selected teeth, selected positions in the jaw, and/or selected orthodontic appliances to be connected to the teeth or jaw is determined. A force to be applied to the determined attachment points to move at least one tooth a predetermined distance and direction in the jaw taking into account the bone density through which the at least one tooth must move is calculated.

### RELATED APPLICATIONS

The present application is related to U.S. Provisional Patent Application Ser. No. 60/877,292, filed on Dec. 27, 2006, which is incorporated herein by reference and to which priority is claimed pursuant to 35 USC 119.

### BACKGROUND OF THE INVENTION

### Field of the Invention

The invention relates to the field of orthodontics where forces dependent on bone density measurements are determined from data taken from a scan.

### BRIEF SUMMARY OF THE INVENTION

The illustrated embodiment of the invention is a method of determining and applying orthodontic forces dependent on bone density measurements comprising the steps of measuring bone density data in a scan of at least a portion of the teeth and jaw to produce a visual map of bone density is a selected area of the jaw. A two or three dimensional image of at least a portion of the jaw and teeth in the selected area of the jaw is generated. The bone density image is mapped into the two or three dimensional image. The attachment points on selected teeth, selected positions in the jaw, and/or selected orthodontic appliances to be connected to the teeth or jaw is determined. A force to be applied to the determined attachment points to move at least one tooth a predetermined distance and direction in the jaw taking into account the bone density through which the at least one tooth must move is calculated.

The step of calculating the force comprises taking into account the shape and/or type of tooth to be moved.

The step of measuring bone density data comprises measuring the bone density in a Houndsfield Scale.

The step of calculating the force comprises specifying a magnitude and direction of the effective a force, and/or specifying a force module or an orthodontic appliance to be used.

The step of calculating the force comprises generating a prescription of an orthodontic procedure to be performed based at least upon force vectors, bone density, point of rotation of the force on the tooth roots, or other selected orthodontic parameters.

The method further comprises the step of obtaining supplemental information relating to detailed three dimensional data about the tooth or teeth to be moved including the surface area of the roots or of an entire tooth if impacted.

The step of obtaining supplemental information comprises calculating the effect of the shape of the tooth to be moved on the pressures applied to the bone adjacent to the moving tooth, including on the pressure side.

The method further comprises the step of selecting the tooth or group of teeth to move and the intended destination of the selected tooth or group of teeth, and calculating where the anchorage for the force to effect such movement should be placed, including whether another tooth would be an adequate anchor or if some type of bone plate or screw in the bone is required and if so where, so that the screw or plate is placed where it would not damage other dental structures.

The step of calculating where the anchorage for the force to effect such movement should be placed comprises determining whether other types of added anchorage devices attached to teeth are to be used.

The method further comprises the step of inputting a path for movement of a tooth or group of teeth and determining attachments points, anchor points and/or forces and/or a sequence of attachments points, anchor points and/or forces to effect movement along the path taking into account anatomical dental features in the path.

The illustrated embodiment also includes a computer and dental measurement system capable of performing any one, a selected combination or all of the foregoing method steps.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a block diagram of a system of the invention in which the method of the invention is practiced.

FIG. 2 is a side x-ray display image of a patient according to the invention illustrating an anchorage screw X and computation of a force to achieve movement of a target tooth.

FIG. 3 is a frontal x-ray display image of a patient according to the invention illustrating movement of a group of teeth.

FIG. 4 is a frontal x-ray display image of a patient according to the invention illustrating movement of a group of teeth.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

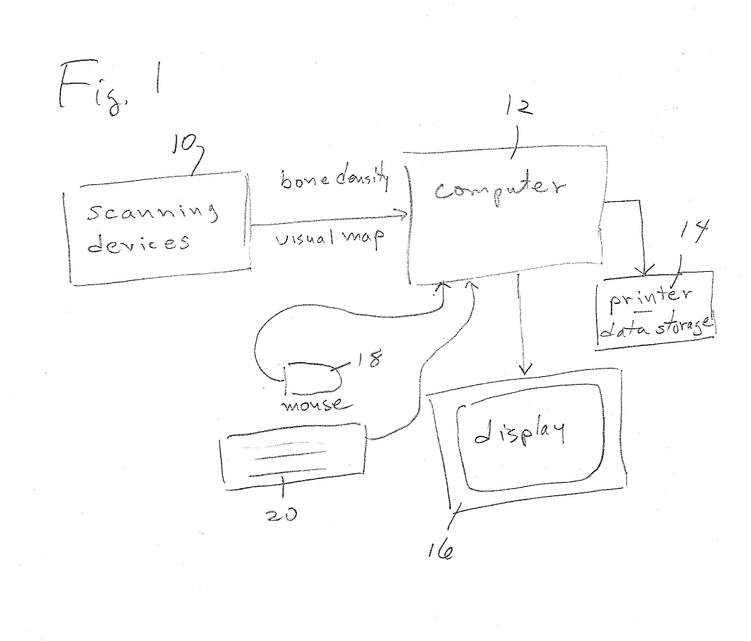

The illustrated embodiment of the invention as depicted in the block diagram of FIG. 1 is a method and system of determining and applying orthodontic forces dependent on bone density measurements in which data is taken from any kind of scanning device 10, such as an ICAT cone beam, any type of 3D scan, ultra sound, CAT scan, or MRI, to make the bone density measurements in the jaw to produce a visual map. Also used as input data is supplemental information providing detailed three dimensional data about the tooth or teeth to be moved including the surface area of the roots or entire teeth if impacted. Calculations are performed in a computer 12 to determine the effect of the shape of the tooth to be moved on the pressures applied to the bone adjacent to the moving tooth, especially on the pressure side.

One such multimode data measurement system which could provide input data measurements combining x-ray and photographic images into a calculated bone density map of the jaw is shown in U.S. Pat. No. 6,081,739, which is incorporated herein by reference. What results is a two or three dimensional map of the image of the teeth or some portion of the jaw and teeth, and the bone density of the jaw in the subject area.

The two or three dimensional image, including bone density information throughout the image volume, is displayed on an interactive computer screen 16. The dentist or surgeon clicks on an image of a target tooth to be moved to a destination point for the target tooth using mouse 18 and/or keyboard 20, including the target tooth's intended position and three dimensions of orientation, and clicks on a second tooth or a spot in the bone of the upper or lower jaw, where an anchor screw could be or is to be implanted. The practitioner could also designate the tooth or teeth to be moved, and the desired final destination or transitional destination. The program shows the best feasible location for an anchor to be placed, including the type or number of anchorage devices required. Hard copy and/or digital records are produced by printer or storage device 14.

Using known orthodontic principles and conventional computer software, a computer program calculates the ideal force to apply to the teeth through a specific orthodontic appliance or device in order to move the chosen tooth or group of teeth between two points in the jaw. The tooth or group of teeth chosen to be moved and the amount of force to be applied, as well as the nature and type of tooth, will determine which tooth or group of teeth moves and which tooth or group of teeth does not move, or how both the target tooth or teeth and the anchor tooth or teeth would move in the jaw.

Included in the calculus is the empirical measurement of the bone density on the Houndsfield Scale or other bone density scale or measurement through which bone the tooth or group of teeth must move in order to achieve the desired displacement. The tooth may actually move through various densities of bone and require changes in force as movement progresses in time.

From the three dimensional image using the method and apparatus of the invention the orthodontist gathers the information regarding the shape of the tooth or teeth. This includes the magnitude of the area, e.g. mm², of root surface of the tooth contacting the bone, and takes into account what part of the tooth or teeth will be applying pressure on the surrounding bone when the tooth or teeth are “pulled” or “pushed” to the desired location. This is like a “boat” cutting through the water, but in this case the shape of the “boat” is the measured three dimensional shape of the tooth or teeth. The needed pressure is affected by the angle of attack of the tooth shape, and the shape of the side of the root on the pressure side (flat, angular, etc.)). The movement of the tooth will require different magnitudes and directions of force depending upon the orientation of the tooth which is desired at its designated displacement position.

The computer then determines from the input data where to place an anchor or anchors or what to choose for an anchor or anchors, taking into account the same information regarding the shape of the teeth being used as an anchor. Alternatively the practitioner could select the teeth for anchorage, and the computer calculates, given a specified force and based on the measurements and bone density, the nature of the tooth or teeth, and what is chosen as the anchor, whether the targeted tooth or teeth will move and how much, e.g. 2 mm, or tip 30 degrees, as the other or anchor tooth or teeth move back. In some cases it will be the intent to move teeth reciprocally.

A major benefit is that the program indicates the best position for the screws or plates used as anchors, including locating it in an area clear of dental structures such as other tooth roots, sinuses, etc. This creates a force vector analysis for every controlled tooth movement.

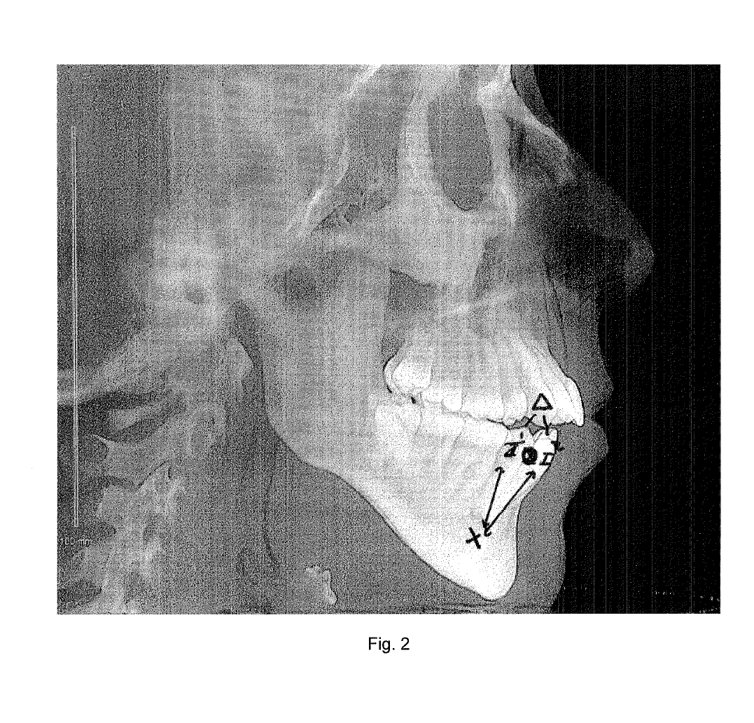

In the preferred embodiment for a surgically placed anchor, the tooth to be moved is selected by the practitioner, and the computer gives the practitioner options regarding the anchor location, orientation, size, depth of placement, etc. The practitioner clicks on a proposed anchorage point, or the exact point where he or she had already placed a screw and the computer calculates the force to be applied. FIG. 2 is a side view x-ray image of a human jaw and teeth subject to orthodontic manipulation. The Δ marking in FIGS. 2-4 marks the target tooth. The mark, “O”, indicates the target location. The mark, “X”, is the anchorage screw or anchorage point used in the orthodontic manipulation or procedure. The mark, “I”, is indirect anchorage, which typically is a tooth which is held by another anchor, to apply force to the target tooth. There is one anchorage screw “X”. In the specific illustration of FIG. 2 the screw X in the jaw is attached to two points, I¹ and I² by fixed wires. The program computes a total of 200 g of force need, 100 g each from I¹ and I² to the target tooth Δ to move it to the target position O.

The system of the illustrated embodiment is also able to work in reverse and given the screw placement, the selection of the attachment on the tooth to be moved, or an arm moving the force up or down to achieve the desire movement, the computer calculates a force needed based upon all other parameters, including bone density, designated by any scale, including the Houndsfield scale.

For example, if the dentist or surgeon wanted to move a cuspid tooth back, he or she would click on the cuspid wherever the dentist wanted to place an attachment on that tooth, or the dentist might have an arm bonded to the tooth for this purpose moving the point at which the force is provided away from the visible or accessible part of the tooth. Then the dentist clicks on an area, perhaps over a back molar, where the dentist plans to put a temporary anchorage screw in the bone of the jaw or an attachment on the molar. The computer then checks the measured bone density along the path of movement and specifies a force, or force module (an orthodontic appliance) to be used, e.g. “use ABC's force module #3”.

The program is also capable of designating a particular type of implant anchor to be placed and through a CAD/CAM fabricated stint allow precise placement of the anchor. The dentist or surgeon then selects the prescribed force module from a kit and places it from the anchor or anchor teeth to the tooth to be moved. The computer calculates the answer or prescription based upon the force vectors, bone density, point of rotation of the force on the tooth roots, and any other orthodontic parameter desired.

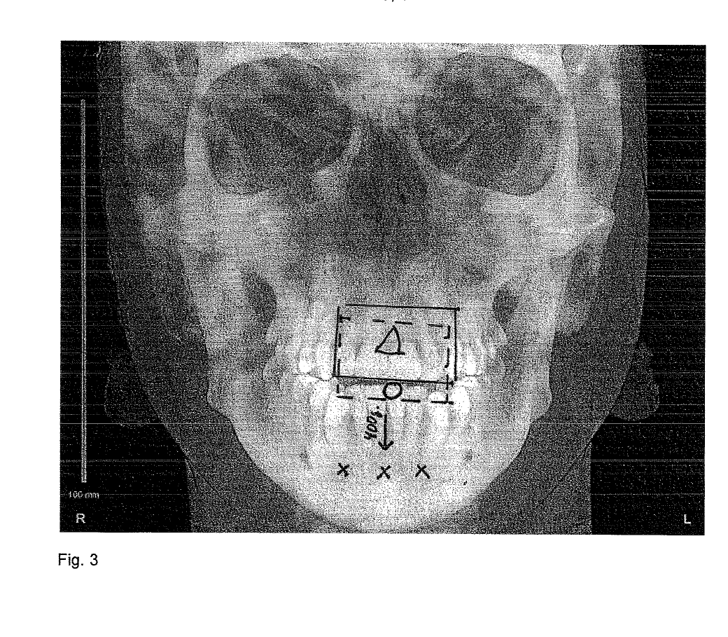

Conversely, the orthodontist could click on the tooth he or she would like to move as well as the anticipated destination of the chosen tooth or group of teeth, and then have the computer calculate where the anchorage for the force should be placed, including whether another tooth would be an adequate anchor or if some type of bone plate or screw in the bone would be required and if so where, making sure the screw or plate is placed where it would not damage other structures. Accommodations for other types of added anchorage devices attached to teeth such as lingual arches, headgears, etc. could be taken into account. FIG. 3 is a frontal x-ray of a patient which illustrates the situation where a group of teeth Δ are to be moved down to contact the lower teeth O. Three “X” points indicate the locations the computer has selected and indicated a force or tension of 400 g in total, so 400 g divided by 3 to be applied from each “X” point, namely 133.3 g each.

The orthodontist clicks on where he or she wants the tooth or teeth to move to, thereby inputting into the program the desired destination, or route of movement. For example, assume the orthodontist first wants the tooth to move down 2 mm and then start to move 3 mm back in order to avoid another tooth in the way. A route or path of movement is thus also input. For example, assume there is an impacted upper cuspid. If the tooth were pulled straight down it might damage the lateral incisor root on the way down, so a desired path length (the measured distance based on the scan) of a certain distance, e.g. 2 mm, is input, and then move the tooth down 5 mm into place. The computer could then determine through the bone density algorithm and program based on this path that there is a need to pull from the attachment on the impacted tooth to location #1 with 3 grams of force. Once the tooth reaches location #2, the computer then determines that one needs to change the anchor to location #3 and move tooth to the final destination. The time expected or needed for a proposed movement is also calculated.

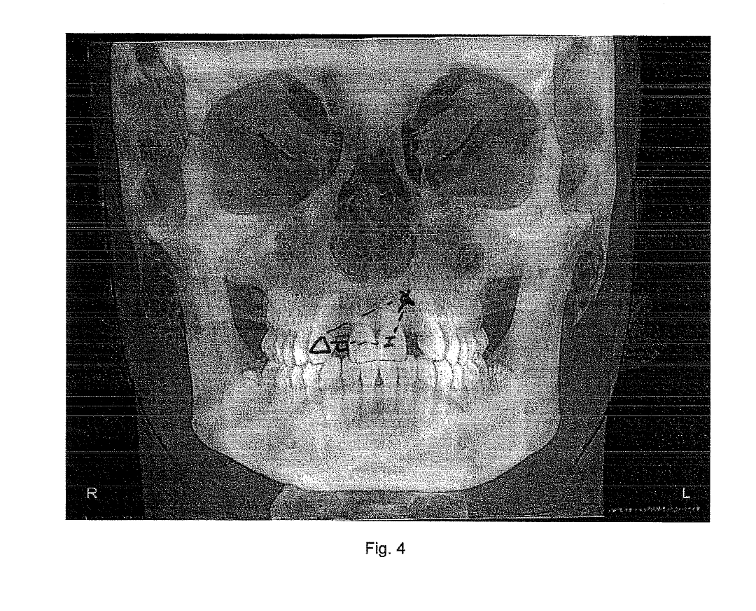

FIG. 4 is a frontal x-ray image of a patient which illustrates a situation where the computer solution provides one anchorage point “X” as a direct anchorage to “I” to act as an indirect anchor, and at the same time provides direct anchorage the target tooth Δ, so the force vector is split. The computer shows the appropriate force triangle to “I” and force triangle to “X” to move the tooth along the desired path of movement to the target location “O”. Step #1 in the program is to select the tooth Δ which is to be moved. Then the user selects the target location O to which the tooth Δ is to be moved. The program calculates the placement of anchorage X, proposes an anchorage device type, and the force required to be placed on tooth Δ. The program considers and proposes multiple direct and indirect anchorage sites where possible or advantageous according to algorithmic standards. In FIG. 4 the program proposed the pattern illustrated with an indirect anchorage I and 100 g of force from direct anchorage X and 50 g from indirect anchorage I.

More complex iterations of movements involving first moving a tooth to one location, then changing the direction of movement could be envisioned as well. The program calculates the square mm's of tooth surface moving through bone of varying densities, consider obstacles (other tooth structures, sinus walls, etc.) The teeth will have be outlined or marked to move a particular part of the tooth, say the cusp tip of a cuspid, to a particular spot, to put it in the proper occlusal (bite) position. It is contemplated that later scans of tooth positions will be taken and the calculation recomputed to either confirm the original orthodontic plan or to provide corrections as needed according to actual tooth movements.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

1. A method of determining and applying orthodontic forces dependent on bone density measurements comprising:
measuring bone density data in a scan of at least a portion of the teeth and jaw to produce a visual map of bone density is a selected area of the jaw;
generating a two or three dimensional image of at least a portion of the jaw and teeth in the selected area of the jaw;
displaying the bone density image mapped into the two or three dimensional image;
determining at least one attachment points on at least one selected tooth, at least one selected positions in the jaw, and/or at least one selected skeletal anchor to be connected to the at least one selected tooth and/or to the at least one selected position in the jaw based on the two or three dimensional bone density along a path in the portion of the jaw through which the at least selected one tooth will be moved to a final location and orientation which the at least one selected tooth is to achieve in the final location; and
calculating a force or a plurality of forces to be applied between the at least one skeletal anchor connected to the selected position in the jaw and the determined attachment points on the at least one selected tooth to move the at least one selected tooth to the selected final location and final orientation along a path whose shape is dependent on the bone density pattern in the portion of the jaw through which the at least one selected tooth must move in order to obtain the final location and orientation.

2. The method of claim 1 where calculating the force or a plurality of forces comprises taking into account the shape and/or type of tooth to be moved.

3. The method of claim 1 where measuring bone density data comprises measuring the bone density in a Houndsfield Scale.

4. The method of claim 1 where calculating the force or plurality of forces comprises specifying a magnitude and direction of the effective a force or forces, and/or specifying a force module or force modules or an skeletal anchor to be used.

5. The method of claim 1 where calculating the force or plurality of forces comprises generating a prescription of an orthodontic procedure involving skeletal anchors to be performed based at least upon force vectors, bone density, point of rotation of the force on the tooth roots, or other selected orthodontic parameters.

6. The method of claim 1 further comprising obtaining supplemental information relating to detailed three dimensional data about the tooth or teeth to be moved including the surface area of the roots or of an entire tooth if impacted.

7. The method of claim 6 where obtaining supplemental information comprises calculating the effect of the shape of the tooth to be moved on the pressures applied to the bone by the skeletal anchor adjacent to the moving tooth, including on the pressure side.

8. The method of claim 1 further comprising selecting the tooth or group of teeth to move and the intended destination of the selected tooth or group of teeth, and calculating where the anchorage point for the skeletal anchor that provides the force to effect such movement should be placed, including whether another tooth would be an adequate anchor point or if some type of additional skeletal anchor in the jaw bone is required and if so where, so that the skeletal anchor is placed in the jaw bone where it would not damage other pre-existing dental structures.

9. The method of claim 8 where calculating where the anchorage point for the skeletal anchor that provides the force to effect such movement should be placed comprises determining whether other types of additional skeletal anchor devices attached to teeth are to be used.

10. The method of claim 1 further comprising inputting a path for movement of a tooth or group of teeth and determining attachments points on the tooth or group of teeth, anchor points in the jaw bone for skeletal anchors and/or forces provided by the skeletal anchors and/or a sequence of attachments points on the tooth or group of teeth, anchor points in the jaw bone for skeletal anchors and/or forces provided by the skeletal anchors to effect movement along the path taking into account anatomical dental features in the path.

11. An apparatus of determining and applying orthodontic forces dependent on bone density measurements comprising:
means for measuring bone density data in a scan of at least a portion of the teeth and jaw to produce a visual map of bone density is a selected area of the jaw;
means for generating a two or three dimensional image of at least a portion of the jaw and teeth in the selected area of the jaw;
a display for displaying the bone density image mapped into the two or three dimensional image;
means for determining at least one attachment points on a selected tooth, at least one selected positions in the jaw, and/or at least one selected skeletal anchor to be connected to the at least one selected tooth and/or selected position in the jaw based on the two or three dimensional bone density pattern based on a path in the portion of the jaw through which the at least selected one tooth is to be moved to a final location and orientation which the at least one selected tooth is to achieve in the final location; and
means for calculating a force or a plurality of forces to be applied between at the least one skeletal anchor connected to the selected position in the jaw and the determined attachment points on the at least one selected tooth to move the at least one selected tooth to the selected final location and final orientation taking into account the bone density pattern in the portion of the jaw through which the at least one selected tooth must move in order to obtain the final location and orientation.

12. The apparatus of claim 11 where the means for calculating the force or plurality of forces comprises means for taking into account the shape and/or type of tooth to be moved.

13. The apparatus of claim 11 where the means for measuring bone density data comprises means for measuring the bone density in a Houndsfield Scale.

14. The apparatus of claim 11 where the means for calculating the force or plurality of forces comprises means for specifying a magnitude and direction of the effective a force or forces, and/or specifying a force module or force modules or an skeletal anchor to be used.

15. The apparatus of claim 11 where the means for calculating the force or plurality of forces comprises means for generating a prescription of an orthodontic procedure involving skeletal anchors to be performed based at least upon force vectors, bone density, point of rotation of the force on the tooth roots, or other selected orthodontic parameters.

16. The apparatus of claim 11 further comprising means for obtaining supplemental information relating to detailed three dimensional data about the tooth or teeth to be moved including the surface area of the roots or of an entire tooth if impacted.

17. The apparatus of claim 16 where the means for obtaining supplemental information comprises means for calculating the effect of the shape of the tooth to be moved on the pressures applied to the bone by the skeletal anchor adjacent to the moving tooth, including on the pressure side.

18. The apparatus of claim 11 further comprising means for selecting the tooth or group of teeth to move and the intended destination of the selected tooth or group of teeth, and calculating where the anchorage point for the skeletal anchor that provides the force to effect such movement should be placed, including whether another tooth would be an adequate anchor point or if some type of additional skeletal anchor in the jaw bone is required and if so where, so that the skeletal anchor is placed in the jaw bone where it would not damage other pre-existing dental structures.

19. The apparatus of claim 18 where the means for calculating where the anchorage point for the skeletal anchor that provides the force to effect such movement should be placed comprises means for determining whether other types of additional skeletal anchor devices attached to teeth are to be used.

20. The apparatus of claim 11 further comprising means for inputting a path for movement of a tooth or group of teeth and determining attachments points on the tooth or group of teeth, anchor points in the jaw bone for skeletal anchors and/or forces provided by the skeletal anchors and/or a sequence of attachments points on the tooth or group of teeth, anchor points in the jaw bone for skeletal anchors and/or forces provided by the skeletal anchors to effect movement along the path taking into account anatomical dental features in the path.

21. A method of determining and applying orthodontic forces dependent on a bone density map in the jaw comprising:
measuring bone density in at least a portion of the jaw to produce a bone density data map in a selected area of the jaw;
generating a data image of at least a portion of the jaw and teeth in the selected area of the jaw;
integrating the data map of bone density with the data image of the selected area of the jaw;
determining a vector solution of one or more orthodontic forces to be applied between one of more teeth and the jaw using one or more skeletal anchors to be connected between one or more teeth and the jaw to move at least one tooth along a path through the jaw having the measured bone density along the path to a final position and orientation, the vector solution being given in terms of the path, and one or more attachment points of the skeletal anchors to the teeth and to the jaw and corresponding forces to be applied.
